(19) United States
(12) Patent Application Publication
(10) Pub. No.: US 2025/0214266 A1
(43) Pub. Date: Jul. 3, 2025

(54) REALIZING A DEFINED EXPOSURE DISTANCE SETTING IN A HAIR-CUTTING UNIT FOR A ROTARY ELECTRIC SHAVER

(71) Applicant: KONINKLIJKE PHILIPS N.V., EINDHOVEN (NL)

(72) Inventor: Marcus Cornelis PETRELLI, GRONINGEN (NL)

(21) Appl. No.: 18/850,111

(22) PCT Filed: Mar. 20, 2023
(86) PCT No.: PCT/EP2023/056985

§ 371 Date: Sep. 24, 2024

(30) Foreign Application Priority Data
Mar. 25, 2022 (EP) 22164311.7

(51) Int. Cl. B26B 19/14; B26B 19/38

(52) U.S. Cl. CPC B26B 19/145; B26B 19/3886

(57) ABSTRACT

In a hair-cutting unit for a rotary electric shaver, which is of the type comprising an external cutting member (10), an internal cutting member and a supporting member (30), an exposure distance over which a skin-contacting surface of a shaving track of the external cutting member (10) protrudes relative to an upper surface of the supporting member (30) is adjustable. To this end, an adjustment system is provided, which comprises, among other things, at least one adjustment set of a guiding channel and a following element (42) engaging the guiding channel, and also an initial position setting system configured to enable synchronization of the exposure distance setting between a number of the hair-cutting units, during which an initial position of the following element (42) in the guiding channel defined by a stop arrangement of the guiding channel is realized and maintained.

### FIELD OF THE INVENTION

The invention relates to a hair-cutting unit for a rotary electric shaver, comprising:
an external cutting member with a shaving track having hair-entry openings;
an internal cutting member which is covered by and rotatable relative to the external cutting member about a central axis of the hair-cutting unit;
a supporting member surrounding and supporting the external cutting member; and
an adjustment system to adjust an exposure distance over which a skin-contacting surface of the shaving track protrudes relative to an upper surface of the supporting member, comprising an adjustment actuator and an adjustment transmission system via which the adjustment actuator is enabled to adjust the exposure distance through mutually relative rotation of the external cutting member and the supporting member about the central axis, wherein the adjustment transmission system comprises a conversion mechanism to convert a mutually relative rotation of the external cutting member and the supporting member about the central axis into a mutually relative axial movement of the external cutting member and the supporting member in an axial direction parallel to the central axis;
   wherein:
the conversion mechanism comprises at least one set of a guiding channel and a following element engaging the guiding channel;
the guiding channel is inclined relative to an imaginary surface perpendicular to the central axis, and is provided on one of i) an inner surface of the supporting member surrounding the external cutting member and ii) a circumferential outer surface of the external cutting member; and
the following element is provided on the other one of i) said inner surface of the supporting member and ii) said outer surface of the external cutting member.

Further, the invention relates to a shaving assembly, comprising at least two hair-cutting units as mentioned here before and a base unit supporting the at least two hair-cutting units, and also relates to a rotary electric shaver comprising a main body and such a shaving assembly, wherein the base unit of the shaving assembly is connected to the main body.

### BACKGROUND OF THE INVENTION

Rotary electric shavers and shaving assemblies for rotary electric shavers are well known. Rotary electric shavers are generally used to shave body hair, which may be facial hair, and are powered by electric supply mains and/or by electric energy storage devices such as batteries.

In a generally known set-up, a shaving assembly comprises an assembly of a base unit and at least one hair-cutting unit supported by the base unit. Traditionally, the hair-cutting unit comprises a combination of an external cutting member having a shaving track provided with hair-entry openings as a non-driven component and an internal cutting member as a driven component, wherein at least the internal cutting member has one or more cutting edges. In such a case, use of the shaving assembly as incorporated in a rotary electric shaver involves putting the shaving assembly to an operation mode in which the internal cutting member of the hair-cutting unit is actually moved, and moving the shaving assembly over the skin in such a way that the shaving track of the external cutting member of the hair-cutting unit faces and contacts the skin. In this process, hairs protruding from the skin are caught in an interior space of the hair-cutting unit in which they are made to abut against the external cutting member at the position of a hair-entry opening and are cut through when they are encountered by a cutting edge of the rotating internal cutting member.

An ongoing issue in the field of rotary electric shavers is a search for practical ways to combine high comfort with high shaving performance, particularly high shaving closeness. Advantageously, the hair-cutting unit is designed such that a user is offered a possibility to adjust the exposure distance over which a skin-contacting surface of the shaving track protrudes relative to an upper surface of the supporting member according to personal desire. Generally speaking, a large exposure distance involves high shaving closeness at the expense of comfort, while a small exposure distance involves high comfort at the expense of shaving closeness.

Various types of an adjustment system to adjust an exposure distance in a hair-cutting unit are known in the art. As indicated, the invention is in the field of an adjustment system comprising an adjustment actuator and an adjustment transmission system via which the adjustment actuator is enabled to adjust the exposure distance through mutually relative rotation of the external cutting member and the supporting member about the central axis, wherein the adjustment transmission system comprises a conversion mechanism to convert a mutually relative rotation of the external cutting member and the supporting member about the central axis into a mutually relative axial movement of the external cutting member and the supporting member in an axial direction parallel to the central axis. In particular, the invention is in the field of such a type of adjustment system, wherein:
the conversion mechanism comprises at least one set of a guiding channel and a following element engaging the guiding channel;
the guiding channel is inclined relative to an imaginary surface perpendicular to the central axis, and is provided on one of i) an inner surface of the supporting member surrounding the external cutting member and ii) a circumferential outer surface of the external cutting member; and
the following element is provided on the other one of i) said inner surface of the supporting member and ii) said outer surface of the external cutting member.

An advantage of using such a type of adjustment system is that it is possible to not only set a minimum or a maximum of the exposure distance, but also any possible value of the exposure distance between the minimum and the maximum, in dependence on a mutually relative rotational position of the external cutting member and the supporting member about the central axis. Without any further measures, this means that when a hair-cutting unit is disassembled, such as for cleaning purposes and/or purposes of replacing one or more components, and is subsequently assembled, the initial exposure distance setting that is obtained at that point is arbitrary. It will be understood that in a situation of two or more hair-cutting units being present in a shaving assembly, this causes the initial exposure distance of the respective hair-cutting units to be different from each other, which is undesirable. It is an object of the invention to provide a way to synchronize the exposure distance setting between hair-cutting units, and to preferably do so without introducing complex and expensive components in the design of the hair-cutting units and/or needing to increase size of the hair-cutting units. Also in a case of a single hair-cutting unit being present in a shaving assembly, it is desirable to have an option of setting a defined initial value of the exposure distance after assembling and disassembling of the hair-cutting assembly, especially when the exposure distance setting is to take place in an automated fashion. In view thereof, the object of the invention can also be formulated as providing a way to realize a defined exposure distance setting, and to preferably do so without introducing complex and expensive components in the design of the hair-cutting units and/or needing to increase size of the hair-cutting units.

### SUMMARY OF THE INVENTION

The invention provides a hair-cutting unit for a rotary electric shaver, comprising:
an external cutting member with a shaving track having hair-entry openings;
an internal cutting member which is covered by and rotatable relative to the external cutting member about a central axis of the hair-cutting unit;
a supporting member surrounding and supporting the external cutting member; and
an adjustment system to adjust an exposure distance over which a skin-contacting surface of the shaving track protrudes relative to an upper surface of the supporting member, comprising an adjustment actuator and an adjustment transmission system via which the adjustment actuator is enabled to adjust the exposure distance through mutually relative rotation of the external cutting member and the supporting member about the central axis, wherein the adjustment transmission system comprises a conversion mechanism to convert a mutually relative rotation of the external cutting member and the supporting member about the central axis into a mutually relative axial movement of the external cutting member and the supporting member in an axial direction parallel to the central axis;
   wherein:
the conversion mechanism comprises at least one set of a guiding channel and a following element engaging the guiding channel;
the guiding channel is inclined relative to an imaginary surface perpendicular to the central axis, and is provided on one of i) an inner surface of the supporting member surrounding the external cutting member and ii) a circumferential outer surface of the external cutting member;
the following element is provided on the other one of i) said inner surface of the supporting member and ii) said outer surface of the external cutting member;
the guiding channel comprises a stop arrangement defining an initial position for the following element in the guiding channel corresponding to one of a minimum and a maximum of the exposure distance;
the adjustment actuator is operable in a first active state to realize mutually relative rotation of the external cutting member and the supporting member in a first rotational direction about the central axis whereby displacement of the following element in a direction towards the initial position in the guiding channel is obtained, and in a second active state to realize mutually relative rotation of the external cutting member and the supporting member in a second rotational direction about the central axis that is opposite to the first rotational direction; and
the adjustment transmission system further comprises an initial position setting system configured to stop the mutually relative axial movement of the external cutting member and the supporting member, and, thereby, to maintain said one of the minimum and the maximum of the exposure distance, during continued operation of the adjustment actuator in the first active state, when the following element reaches the initial position in the guiding channel.

It follows from the above definition of the hair-cutting unit according to the invention that the adjustment system which is included in the hair-cutting unit to adjust the exposure distance is designed such that one of a minimum and a maximum of the exposure distance can be set as an initial value of the exposure distance, and that this initial value of the exposure distance can be maintained even if a mutually relative rotation of the external cutting member and the supporting member on the basis of which the initial value of the exposure distance was obtained in the first place is continued. As defined, the adjustment transmission system of the adjustment system comprises an initial position setting system configured to stop the mutually relative axial movement of the external cutting member and the supporting member, and, thereby, to maintain the initial value of the exposure distance, as soon as the initial value of the exposure distance is reached as a result of the adjustment actuator being operated in a first active state. It is on the basis of the working principle of the initial position setting system, combined with the presence of a stop arrangement in the guiding channel of the at least one set of a guiding channel and a following element of the conversion mechanism of the adjustment transmission system, that it is possible to synchronize the exposure distance setting in respective hair-cutting units, even if the mutually relative rotation of the external cutting member and the supporting member in the respective hair-cutting units is realized by means of a common adjustment actuator of the adjustment systems of the hair-cutting units. The fact is that when the initial value of the exposure distance is obtained in a first one of the hair-cutting units, the same can be done in the one or more others of the hair-cutting units without disturbing the setting of the exposure distance in the first one, because at that point, the initial position setting system of the first one acts to stop the mutually relative axial movement of the external cutting member and the supporting member. For the reason that putting to practice the invention offers the possibility to realize a defined exposure distance setting in a hair-cutting unit, the invention is also useful in a case of a single hair-cutting unit being used in a shaving assembly.

At the level of the at least one set of a guiding channel and a following element, what happens at first is that when the adjustment actuator is operated in the first active state, displacement of the following element in a direction towards the initial position in the guiding channel is obtained. When the following element reaches the initial position in the guiding channel defined by the stop arrangement, the initial position setting system enables keeping the following element at that very position, during continued operation of the adjustment actuator in the first active state. The guiding channel and the following element may be of any suitable design. The guiding channel can be provided as a groove in a surface, while the following element can be provided as a rib-like feature having an elevated position on a surface.

In the context of the invention, various embodiments of the initial position setting system which are configured to realize the advantageous functionality as described here before in a completely mechanical fashion are feasible. In the following, two possibilities will be defined and explained, wherein it is noted that each of the two possibilities are applicable to an embodiment of the hair-cutting unit in which the external cutting member is rotatable relative to the supporting member about the central axis.

According to a first possibility, the initial position setting system is configured to disable the adjustment actuator to act on the external cutting member, during continued operation of the adjustment actuator in the first active state, when the following element reaches the initial position in the guiding channel. In a practical embodiment, the adjustment transmission system comprises a driven gear wheel mounted to the external cutting member and the adjustment actuator comprises a driving gear wheel engaging the driven gear wheel, and the first and second active states of the adjustment actuator involve respective opposite first and second directions of rotation of the driving gear wheel. In that case, it may be so that the initial position setting system comprises, for each set of a guiding channel and a following element, a void section of the driven gear wheel in which no gear teeth are present, and that the void section is positioned relative to the one of the guiding channel and the following element which is provided on the outer surface of the external cutting member such that the void section faces the driving gear wheel to disable the driving gear wheel from driving the driven gear wheel when the following element is at the initial position in the guiding channel. Thus, stopping mutually relative displacement of the guiding channel and the following element from the moment that the following element reaches the initial position in the guiding channel, despite continued rotation of the driving gear wheel, is achieved on the basis of a special design of the driven gear wheel. In order to enable the driving gear wheel to again engage and drive the driven gear wheel when the direction of rotation of the driving gear wheel is reversed, it is advantageous if the stop arrangement of the guiding channel of one of the at least one set of a guiding channel and a following element comprises a resilient element configured to bias the following element out of the initial position in the guiding channel when the following element is at the initial position in the guiding channel.

According to a second possibility, the guiding channel is provided on a carrier portion of the supporting member, and the initial position setting system is configured to enable rotation of the carrier portion relative to a main portion of the supporting member about the central axis together with the external cutting member, during continued operation of the adjustment actuator in the first active state, when the following element reaches the initial position in the guiding channel. Thus, stopping mutually relative displacement of the guiding channel and the following element from the moment that the following element reaches the initial position in the guiding channel, despite continued rotation of the external cutting member, is achieved by providing the guiding channel in a carrier portion of the supporting member 30 and enabling the carrier portion to rotate together with the external cutting member to thereby allow a situation in which the following element is at the initial position in the guiding channel as long as the direction of rotation of the external cutting member is not reversed. It may be so that the initial position setting system comprises a holding arrangement to retain the carrier portion in a stationary position in the main portion of the supporting member when the following element is at another position than the initial position in the guiding channel, and to enable the carrier portion to rotate relative to the main portion of the supporting member about the central axis when the adjustment actuator operates in the first active state and the following element reaches the initial position in the guiding channel. A practical example of such a holding arrangement is a holding arrangement comprising friction structures in surfaces of the carrier portion and/or the main portion of the supporting member contacting each other and extending in a tangential direction about the central axis.

It may be practical if the guiding channel is provided on the inner surface of the supporting member surrounding the external cutting member, and the following element is provided on the circumferential outer surface of the external cutting member, but that does not alter the fact that the invention also covers an option of the guiding channel being provided on said outer surface of the external cutting member, and the following element being provided on said inner surface of the supporting member.

In order to offer a user an opportunity to take apart the external cutting member and the supporting member, it is practical if the guiding channel comprises an opening via which the following element can be removed from the guiding channel by manually moving the external cutting member and the supporting member relative to each other in the axial direction. It may be practical if said opening is arranged in a position in the guiding channel that is outside of a range of positions in the guiding channel taken by the following element during normal operation of the hair-cutting unit, i.e. with the exposure distance having a value in the range from said minimum to said maximum, as way of preventing that the following element is released from the guiding channel during said normal operation, such as under the influence of external forces acting on the external cutting member during said normal operation. It may particularly be so that as seen with respect to said range of positions taken by the following element during said normal operation of the hair-cutting unit, the position of the opening is opposite to said initial position of the following element, corresponding to said one of the minimum and the maximum of the exposure distance, and beyond a position of the following element corresponding to the other of the minimum and the maximum of the exposure distance. Other measures aimed at preventing that the following element is released from the guiding channel during said normal operation of the hair-cutting unit are feasible in the context of the invention as well, which measures may be constructional measures.

In a practical embodiment of the hair-cutting unit according to the invention, the conversion mechanism comprises three sets of a guiding channel and a following element, the three sets being arranged at angular intervals of 120° about the central axis, which guarantees stability and robustness of the hair-cutting unit.

It may be sufficient if the adjustment system is configured to realize mutually relative rotation of the external cutting member and the supporting member over a limited angle about the central axis. The limited angle is chosen in view of the angle needed to vary the exposure distance between the minimum and the maximum.

For the sake of completeness, it is noted that in the hair-cutting unit according to the invention, in the case that the external cutting member is rotatable about the central axis, the external cutting member and the internal cutting member are drivable independently from each other.

The invention further relates to a shaving assembly comprising at least two hair-cutting units as described here before and a base unit supporting the at least two hair-cutting units. It is advantageous if the adjustment actuator of each of the hair-cutting units is configured to be operated such that, when operation of the shaving assembly is initiated, an action aimed at ensuring that the exposure distance is the same in all of the hair-cutting units is performed. In view of the foregoing, this implies that the adjustment actuator of each of the hair-cutting units is configured to be operated in the first active state during an initial operational phase of the shaving assembly, such that, in each of the hair-cutting units, the following element of the at least one set of a guiding channel and a following element is enabled to reach the initial position in the guiding channel.

As suggested earlier, it is possible that the adjustment systems of the hair-cutting units comprise a common adjustment actuator. In this respect, it is noted that the common adjustment actuator may comprise a common driving gear wheel arranged centrally between the hair-cutting units. Using a common driving gear wheel contributes to compactness of the hair-cutting units and is also advantageous in view of the fact that rotatory drive synchronization is directly and automatically obtained.

Finally, the invention also relates to a rotary electric shaver comprising a main body and a shaving assembly as described here before, wherein the base unit of the shaving assembly is connected to the main body.

The above-described and other aspects of the invention will be apparent from and elucidated with reference to the following detailed description of two embodiments of a hair-cutting unit comprising an external cutting member, an internal cutting member, a supporting member and an adjustment system for adjusting an exposure distance over which a skin-contacting surface of a shaving track of the external cutting member protrudes relative to an upper surface of the supporting member, which adjustment system is configured to enable synchronization of the exposure distance setting between a number of the hair-cutting units in a shaving assembly.

### BRIEF DESCRIPTION OF THE DRAWINGS

The invention will now be explained in greater detail with reference to the figures, in which equal or similar parts are indicated by the same reference signs, and in which:

FIG. 1 diagrammatically shows a perspective view of a rotary electric shaver according to an embodiment of the invention, which rotary electric shaver comprises a shaving assembly and a main body;

FIG. 2 diagrammatically shows a perspective view of an external cutting member, a decorative cap and an internal cutting member of a hair-cutting unit of the shaving assembly, wherein both the external cutting member and the cap are shown with a portion cut away;

FIG. 3 diagrammatically shows a perspective view of an external cutting member assembly including an external cutting member, a driven gear wheel mounted to the external cutting member, and following elements arranged on the external cutting member;

FIGS. 4 and 5 illustrate two different exposure distance settings in the hair-cutting unit;

FIG. 6 diagrammatically shows a perspective view of a supporting member of a hair-cutting unit according to a first practical embodiment of the invention;

FIG. 7 diagrammatically shows a bottom view of the external cutting member assembly and the supporting member of three hair-cutting units according to the first practical embodiment of the invention, and a common driving gear wheel;

FIG. 8 diagrammatically shows a perspective view of the external cutting member assembly of the hair-cutting unit according to the first practical embodiment of the invention;

FIG. 9 diagrammatically shows a perspective view of a supporting member of a hair-cutting unit according to a second practical embodiment of the invention, which has a carrier portion on which guiding channels of three sets of a guiding channel and a following element are arranged;

FIG. 10 diagrammatically shows a separate perspective view of the supporting member shown in FIG. 9, without the carrier portion; and

FIG. 11 diagrammatically shows a separate perspective view of the carrier portion.

### DETAILED DESCRIPTION OF THE EMBODIMENTS

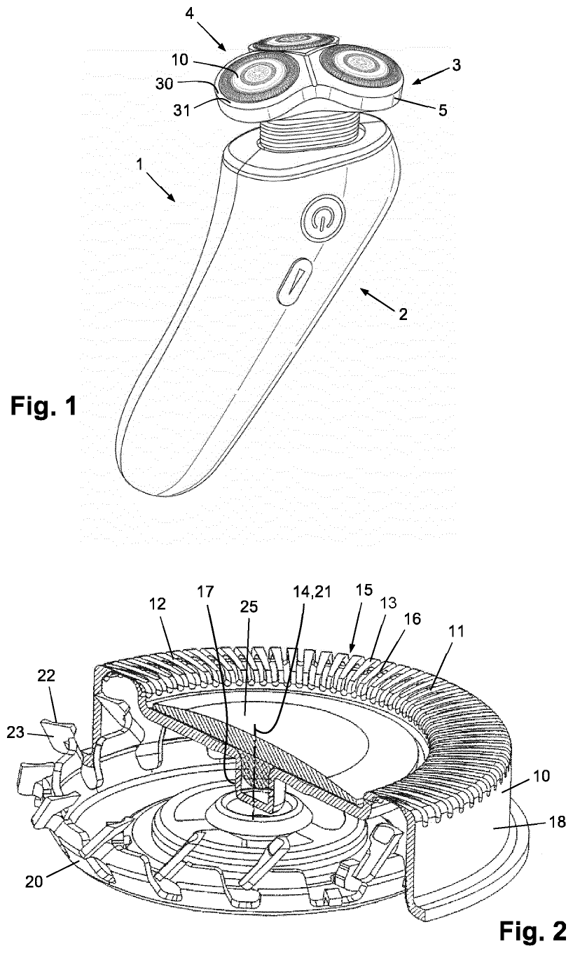

FIG. 1 shows an electric shaver of the rotary type, which is suitable to be used for shaving a beard, as a practical example of a rotary electric shaver 1 according to an embodiment of the invention. The rotary electric shaver 1 comprises a main body 2 and a shaving assembly 3, wherein the main body 2 is designed to enable a user of the shaver 1 to take hold of the shaver 1 and to handle the shaver 1, and wherein the shaving assembly 3 is the part of the shaver 1 that is to be positioned on and moved over the skin for hair removal. In the present example, the shaving assembly 3 comprises three hair-cutting units 4 supported on a base unit 5 of the shaving assembly 3. When the rotary electric shaver 1 is actually applied for the purpose of performing a shaving action, the actual process of cutting of hairs protruding from the skin takes place at the position of the hair-cutting units 4. In the context of the invention, the number of hair-cutting units 4 can be chosen freely and does not necessarily need to be three. The main body 2 may have a function in accommodating at least one electric motor for driving components of the respective hair-cutting units 4. The main body 2 may further include means such as a rechargeable battery for powering the at least one electric motor. It is practical if the shaving assembly 3 and the main body 2 are releasably connectable to each other, as known per se in the field of rotary electric shavers.

Each of the hair-cutting units 4 comprises a combination of an external cutting member 10 and an internal cutting member 20, as will now be described in more detail with reference to FIG. 2. The external cutting member 10 is of a generally cup-shaped design and is thereby suitable for at least partially accommodating the internal cutting member 20 in its interior. The external cutting member 10 has an annular shaving track 11, an upper surface of the shaving track 11 being a skin-contacting surface 12 intended to face and contact the skin to be subjected to a shaving action. The shaving track 11 comprises lamellae 13 extending along the width of the shaving track 11, in a substantially radial direction relative to a central axis 14 of the hair-cutting unit 4, which coincides with a rotational axis 21 about which the internal cutting member 20 is rotatable relative to the external cutting member 10. Apertures as present between the lamellae 13 constitute hair-entry openings 15 of the shaving track 11. Sides of the lamellae 13 constitute hair-cutting surfaces 16 suitable for cutting off hairs in cooperation with hair-cutting edges 22 of hair-cutting elements 23 of the internal cutting member 20. The invention also relates to cases in which the shaving track 11 does not comprise lamellae 13 or does not only comprise lamellae 13, such as cases in which the entire shaving track 11 is provided with teeth-like elements and/or a pattern of (circular) holes instead of or in addition to lamellae 13. Also, the invention relates to cases in which more than one shaving track 11 is present in the external cutting member 10.

A shaving action can be performed when the internal cutting member 20 is activated to rotate and a portion of skin is actually contacted by the external cutting member 10 at the position of the skin-contacting surface 12. Activation of the internal cutting member 20 may take place in a known manner by means of a drive mechanism of the rotary electric shaver 1. When the combination of the external cutting member 10 and the internal cutting member 20 is moved over the portion of skin while the internal cutting member 20 is driven to rotate, it is achieved that hairs protruding from the portion of skin are caught in the hair-entry openings 15 of the shaving track 11 of the external cutting member 10 and are cut off in that position as result of a cooperation between the hair-cutting surfaces 16 of the shaving track 11 of the external cutting member 10 and the hair-cutting edges 22 of the hair-cutting elements 23 of the rotating internal cutting member 20.

Besides the shaving track 11, the external cutting member 10 includes a central portion 17 comprising a central bearing portion which is designed to be used in rotationally supporting the internal cutting member 20 in the hair-cutting unit 4. The central portion 17 of the external cutting member 10 also serves for supporting a decorative cap 25 configured to cover part of the exterior surface of the external cutting member 10. In the present example, the central portion 17 comprises a centrally located recess, and the cap 25 comprises a projection which is accommodated in the recess.

Each of the hair-cutting units 4 further comprises a supporting member 30. The supporting member 30 has a upper surface 31 surrounding the external cutting member 10. According to the invention, each hair-cutting unit 4 comprises an adjustment system to adjust an exposure distance de over which the skin-contacting surface 12 of the shaving track 11 protrudes relative to the upper surface 31 of the supporting member 30, as will now be explained. On the basis of the presence of an adjustment system in the hair-cutting unit 4, a user is enabled to set the exposure distance de in accordance with personal preferences, wherein it is to be noted that these personal preferences may be different for different skin areas to be subjected to a shaving action. Generally speaking, the adjustment system comprises an adjustment actuator and an adjustment transmission system via which the adjustment actuator is enabled to adjust the exposure distance de through mutually relative rotation of the external cutting member 10 and the supporting member 30 about the central axis 14, and the adjustment transmission system comprises a conversion mechanism to covert a mutually relative rotation of the external cutting member 10 and the supporting member 30 about the central axis 14 into a mutually relative axial movement of the external cutting member 10 and the supporting member 30 in an axis direction A parallel to the central axis 14. In the present example, the external cutting member 10 is rotatable, over a limited angle, and also displaceable in the axial direction A in a limited range, while the supporting member 30 is a stationary component of the hair-cutting unit 4. Hence, in the present example, realizing a mutually relative rotation of the external cutting member 10 and the supporting member 30 about the central axis 14 is done by realizing a rotation of the external cutting member 10 about the central axis 14, and realizing a mutually relative movement of the external cutting member 10 and the supporting member 30 in the axial direction A is done by realizing a movement of the external cutting member 10 in the axial direction A.

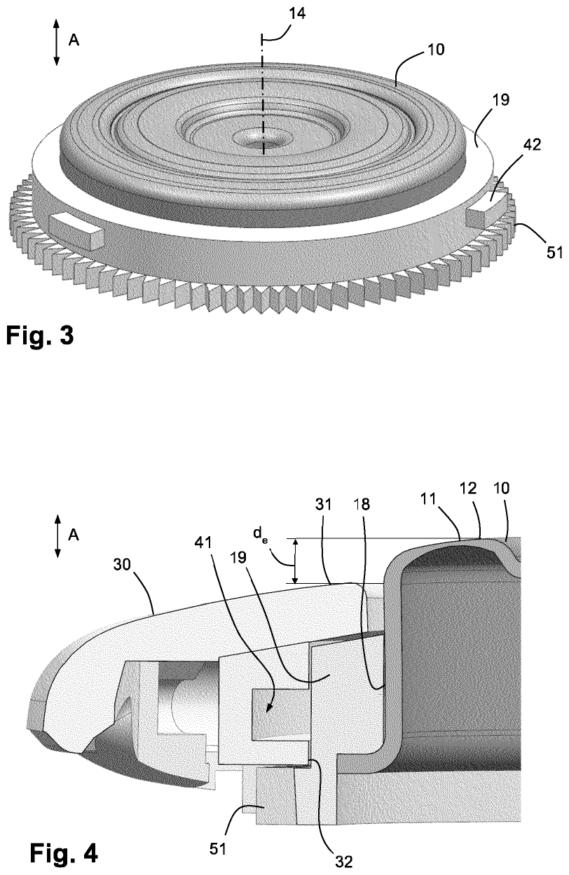

The above-mentioned conversion mechanism of the adjustment transmission system comprises at least one set of a guiding channel 41 and a following element 42, which set will hereinafter be referred to as adjustment set. On the basis of FIGS. 3-5, the general working principle of this type of conversion mechanism will now be explained. In FIG. 3, the external cutting member 10 is shown, wherein the external cutting member 10 is partially depicted in a simplified fashion such that particularly the hair-entry openings 15 of the shaving track 11 cannot be seen. For the sake of completeness, it is noted that terms such as “upper”, “top” and “bottom” as used in the present text are to be understood in relation to the assumption that in the hair-cutting unit 4, the position of the shaving track 11 relative to the position of the internal cutting member 20 is a higher position in the axial direction A.

Among other things, FIG. 3 serves to illustrate that it is practical to have three adjustment sets, wherein the three adjustment sets are arranged at angular intervals of 120° about the central axis 14, and wherein the guiding channels 41 are provided on an inner surface 32 of the supporting member 30 while the following elements 42 are provided on a circumferential outer surface 18 of the external cutting member 10, which does not alter the fact that other options are covered by the invention as well. In FIG. 3, two of the three following elements 42 as arranged on the external cutting member 10 are visible. Further, a driven gear wheel 51 mounted to the external cutting member 10 can be seen in FIG. 3. Like the conversion mechanism, this driven gear wheel 51 is part of the adjustment transmission system. As illustrated in FIG. 3, it may be practical if the following elements 42 and the driven gear wheel 51 are integrated in a single component 19.

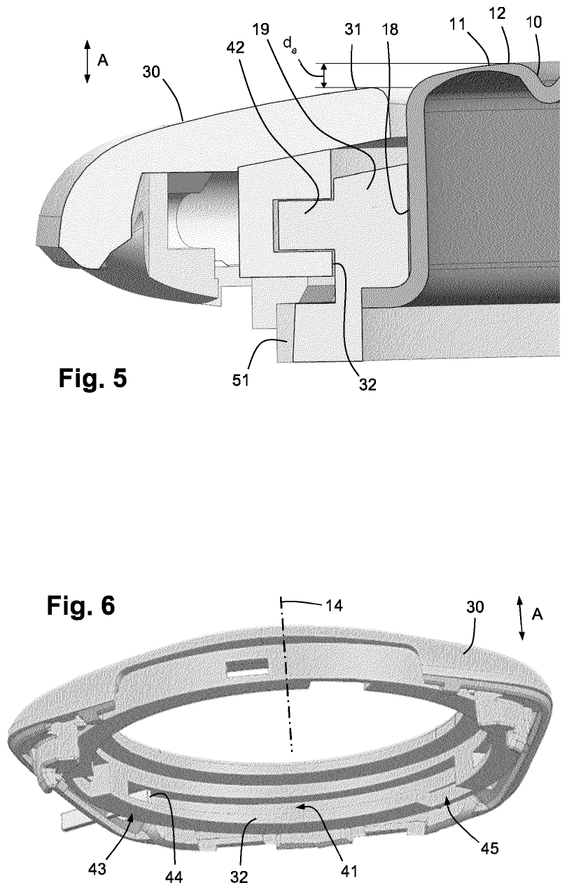

A specific feature of the guiding channel 41 resides in the general fact that the guiding channel 41 is inclined relative to an imaginary surface perpendicular to the central axis 14. Consequently, when the external cutting member 10 is rotated about the central axis 14, the interaction between the guiding channel 41 and the following element 42 of the respective adjustment sets is such that the external cutting member 10 is further lifted or lowered relative to the supporting member 30 in the axial direction A, depending on the direction in which the external cutting member 10 is rotated. In FIGS. 4 and 5, the same section of a portion of a hair-cutting unit 4 is shown, for different rotational positions of the external cutting member 10 about the central axis 14. Taking the situation illustrated in FIG. 4 as a starting point, the situation illustrated in FIG. 5 is obtained by rotating the external cutting member 10 about the central axis 14, over a limited angle. In this process, as can clearly be seen when the figures are compared to each other, the external cutting member 10 is lowered relative to the supporting member 30, as a result of which the value of the exposure distance de decreases. From the situation illustrated in FIG. 5, the situation illustrated in FIG. 4 can be restored by rotating the external cutting member 10 about the central axis 14, over the same limited angle, but in the opposite rotational direction.

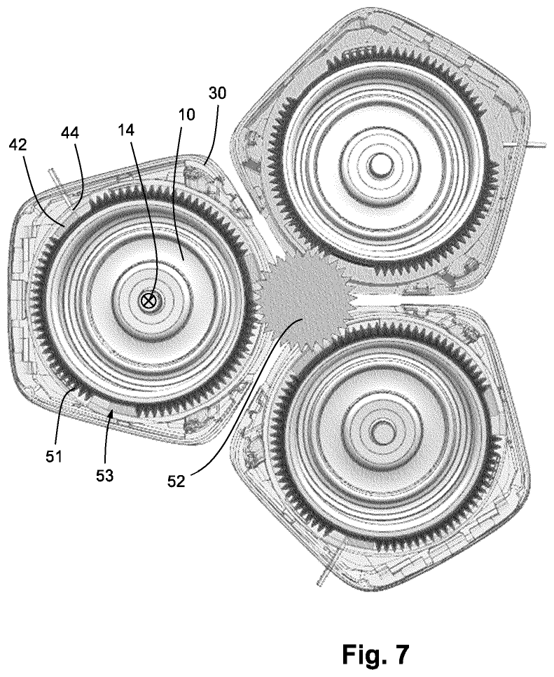

FIGS. 6-8 relate to a hair-cutting unit 4 according to a first practical embodiment of the invention. In FIG. 6, the supporting member 30 of the hair-cutting unit 4 is shown. In this figure, it can be seen that the guiding channel 41 comprises a stop arrangement 43 defining an initial position for the following element 42 in the guiding channel 41 corresponding to a minimum of the exposure distance de, the stop arrangement 43 being at an end of the guiding channel 41 that is lowest in the axial direction A. Also, it can be seen that the stop arrangement 43 of the guiding channel 41 of one of the adjustment sets comprises a resilient element in the form of a pretensioned spring 44. In FIG. 7, components of three of the hair-cutting units 4 are shown, as part of a shaving assembly 3 comprising the hair-cutting units 4. The components comprise the external cutting member 10 and the supporting member 30, wherein it is noted that, like in FIG. 3, the external cutting member 10 is partially depicted in a simplified fashion such that particularly the hair-entry openings 15 of the shaving track 11 cannot be seen. Also, a driving gear wheel 52 which is arranged centrally between the hair-cutting units 4 is shown, as a practical example of a component of the adjustment actuator, which driving gear wheel 52 is capable of realizing a rotation of the external cutting member 10 of each of the hair-cutting units 4 about the respective central axis 14. In this respect, it is noted that the driving gear wheel 52 can be driven by an electric motor which is provided for that purpose only. In such a case, when it is appropriate to change the direction in which the driving gear wheel 52 is rotated, the electric motor can be controlled to reverse the rotational direction of the output shaft thereof, or a coupling arrangement as may be present between the output shaft of the electric motor and the driving gear wheel 52 can be adjusted to reverse the way in which a rotation of the output shaft of the electric motor is transferred to the driving gear wheel 52. Having a dedicated electric motor offers the possibility of operating the adjusting system independently from the internal cutting member 20 and changing the value of the exposure distance de during a shaving action if so desired. Hence, the exposure setting de can be an adaptive shaving feature. In a practical case in which a high gear reduction is used between the output shaft of the electric motor and the driving gear wheel 52, exactly realizing a desired exposure distance setting may involve counting rotations of the output shaft.

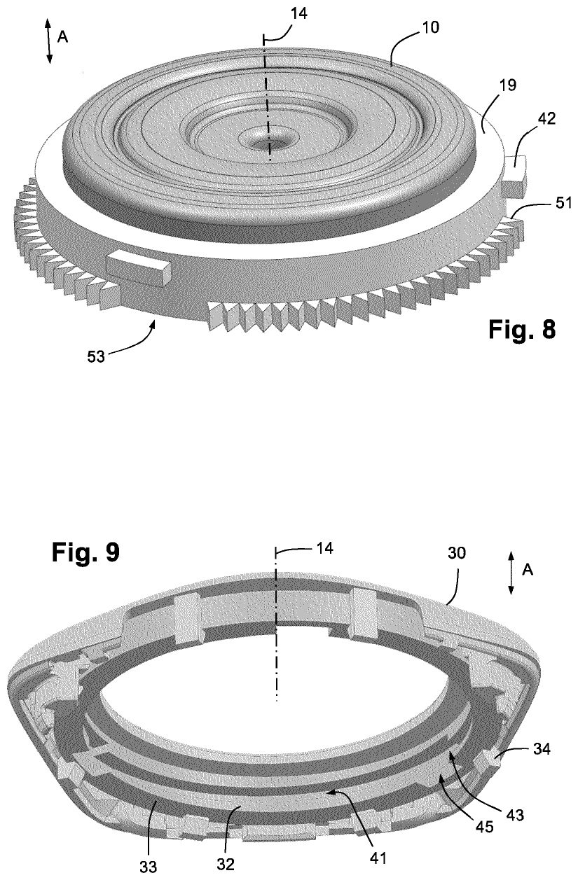

In FIG. 7, it can be seen that in each of the hair-cutting units 4, the driven gear wheel 51 has void sections 53 in which no gear teeth are present, one void section 53 for each of the adjustment sets. A perspective view of the assembly of the external cutting member 10 and the component 19 including the following elements 42 and the driven gear wheel 51 is shown in FIG. 8, wherein the external cutting member 10 is partially depicted in a simplified fashion such that particularly the hair-entry openings 15 of the shaving track 11 cannot be seen, similar to FIGS. 3 and 7. The void sections 53 are positioned in a particular way, namely such that one void section 53 faces the driving gear wheel 52 when in each of the adjustment sets, the following element 42 is at the initial position in the guiding channel 41, thereby disabling the driving gear wheel 52 to drive the driven gear wheel 51. On the basis of the presence of the void sections 53 in the driven gear wheel 52 of each of the hair-cutting units 4, it is possible to realize/guarantee synchronization of the exposure distance setting of the hair-cutting units 4. This is especially relevant in a situation in which the exposure distance setting of the hair-cutting units 4 may be expected to vary from one hair-cutting unit 4 to another, which situation especially occurs after disassembly and subsequent assembly of at least one of the hair-cutting units 4 has been performed by a user. The synchronization is done by rotating the driving gear wheel 52 in a counterclockwise direction as seen in the view of FIG. 7, which is a bottom view. Assuming that the exposure distance setting is different for each of the hair-cutting units 4, indeed, the following happens. At a certain point, in one of the hair-cutting units 4, as a result of the rotation of the external cutting member 10 induced by the rotation of the driving gear wheel 52 through the driven gear wheel 51 mounted to the external cutting member 10, the following element 42 reaches the initial position in the guiding channel 41 in each of the adjustment sets of the respective hair-cutting unit 4, while this is not yet the case in the two other hair-cutting units 4. At that point, a continued rotation of the driving gear wheel 52 does no longer result in a rotation of the driven gear wheel 51 of the one hair-cutting unit 4, because at that point, one of the void sections 53 of the driven gear wheel 51 faces the driving gear wheel 52. As the driving gear wheel 52 continues, the situation in which the following element 42 reaches the initial position in the guiding channel 41 in each of the adjustment sets and the driven gear wheel 51 and the driving gear wheel 52 are decoupled is also achieved in a second of the hair-cutting units 4, and subsequently in a third of the hair-cutting units 4. Thus, eventually, in all of the hair-cutting units 4, an equal exposure distance setting is realized, in which the exposure distance is at the minimum in the present example. It follows from the foregoing that it is due to the design of the driven gear wheel 51 with the void sections 53 that this exposure distance setting can be obtained at different times during a rotation of the driving gear wheel 52 in the counterclockwise direction as seen from a bottom side.

Once synchronization of the exposure distance setting between the hair-cutting units 4 has taken place, it is possible to set any other desired value of the exposure distance de by rotating the driving gear wheel 52 in the clockwise direction as seen from the bottom side. The fact is that in each of the hair-cutting units 4, the pretensioned spring 44 acts to bias the following element 42 of the respective adjustment set out of the initial position in the guiding channel 41 when the following element 42 is at the initial position in the guiding channel 41. Thus, under the influence of the pretensioned spring 44, as soon as the driving gear wheel 52 starts to rotate in the clockwise direction as seen from the bottom side, the driven gear wheel 51 of each of the hair-cutting units 4 and the driving gear wheel 52 are allowed to couple again, and the driven gear wheel 51 of each of the hair-cutting units 4 can be rotated until the rotational position of the external cutting member 10 about the central axis 14 that is appropriate in view of the desired exposure distance setting is obtained.

In view of the foregoing explanation of the way in which the exposure distance setting is synchronized between different hair-cutting units 4, it is noted that it may be practical if a method of controlling of the shaving assembly 3 is chosen which involves a step of rotating the driving gear wheel 52 in the counterclockwise direction as seen from the bottom side, over an angle about the central axis 14 that is sufficiently large to ensure that the minimum of the exposure distance de is achieved in all of the hair-cutting units 4, and performing this step during an initial operational phase of the shaving assembly 3. This can be done as standard routine, which always results in the desired synchronization of the exposure distance setting between the hair-cutting units 4, wherein the angle of rotation may be chosen to be 120° in the present case of three adjustment sets per hair-cutting unit 4. If the desired exposure distance setting is different from having the exposure distance de at the minimum, the desired exposure setting is achieved by subsequently rotating the driving gear wheel 52 in the clockwise direction as seen from the bottom side, over an appropriate angle about the central axis 14, as explained earlier.

When FIGS. 4 and 5 are seen in relation to the hair-cutting unit 4 according to the first practical embodiment of the invention, it is found that a change of the situation illustrated in FIG. 4 to the situation illustrated in FIG. 5 involves a rotation of the driving gear wheel 52 in the counterclockwise direction as seen from the bottom side, as such rotation involves a decrease of the exposure distance de in the hair-cutting unit 4. The invention covers any way of enabling a user to indicate which value of the exposure distance de is to be set, such as through pressing an appropriate button or touching a touchscreen as may be present on the main body 2 of the rotary electric shaver 1 or on a cradle for holding the shaver 1, or by using an app on a mobile device configured to control operation of the shaver 1.

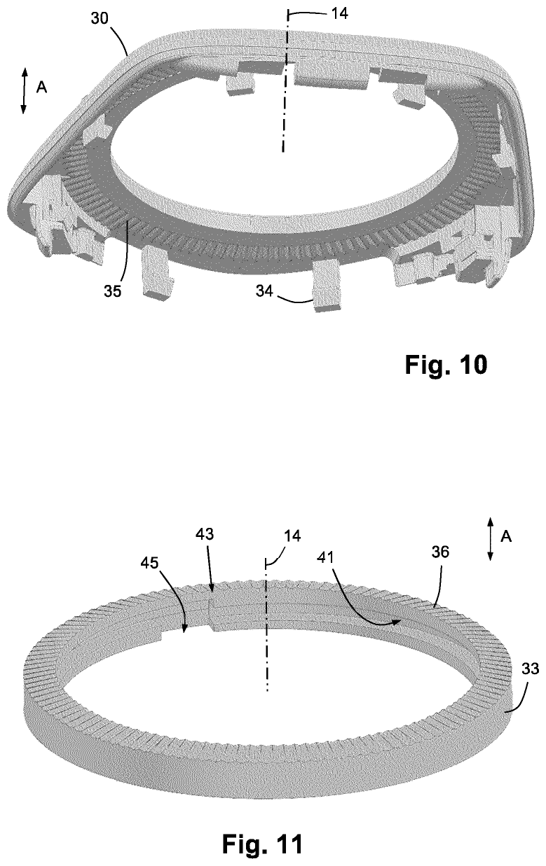

FIGS. 9-11 relate to a hair-cutting unit 4 according to a second practical embodiment of the invention, which is designed to rely on other features than having at least one void section 53 in the driven gear wheel 51. In the first place, it is noted that it can be seen in FIG. 9 that in the hair-cutting unit 4 according to a second practical embodiment of the invention, the stop arrangement 43 of the guiding channel 41 is positioned such that the maximum of the exposure distance de is obtained when the following element 42 is at the initial position in the guiding channel 41. In the second place, it is noted that the guiding channels 41 of the three adjustment sets are provided on a carrier portion 33 of the supporting member 30. In the present example, a main portion of the supporting member 30 is provided with hook-like elements 34 for fixing the axial position of the carrier portion 33 in the main portion of the supporting member 30. Further, it can be seen in FIG. 10 that the main portion of the supporting member 30 is provided with a corrugated annular surface 35, and it can be seen in FIG. 11 that the carrier portion 33 is provided with a corrugated annular surface 36 as well, at a position to face and engage the corrugated annular surface 35 of the main portion of the supporting member 30 when the carrier portion 33 is in place in the supporting member 30. It is the combination of the presence of cooperating corrugated annular surfaces 35, 36 in the supporting member 30 and the presence of the stop arrangement 43 in the guiding channel 41 that allows for synchronization of the exposure distance setting between different hair-cutting units 4 sharing a driving gear wheel 52, as will now be explained.

Assuming a position of the following element 42 in the guiding channel 41 that is different from the initial position in the guiding channel 41 in each of the adjustment sets of a hair-cutting unit 4, and a normal, stationary position of the carrier portion 33 in the main portion of the supporting member 30, it is found that when the external cutting member 10 on which the following element 42 is present is rotated about the central axis 14 in such a direction that the following element 42 eventually abuts against the stop arrangement 43, i.e. reaches the initial position in the guiding channel 41, and that at that point, as rotation of the external cutting member 10 is continued, a moment acting between the carrier portion 33 and the main portion of the supporting member 30 in a tangential direction about the central axis 14 at the position where their corrugated annular surfaces 35, 36 engage each other increases until the friction between the surfaces 35, 36 is overcome and the carrier portion 33 is taken along by the external cutting member 10 to rotate about the central axis 14 as well. In that way, it is achieved that even while rotation of the external cutting member 10 is continued, the situation of the following element 42 being at the initial position in the guiding channel 41 and the associated maximum of the exposure value de is preserved, without an urge to move the following element 42 away from said position. Thus, on the basis of the fact that the carrier portion 33 can be made to rotate about the central axis 14 when the following element 42 is at the initial position in the guiding channel 41, it is possible to realize synchronization of the exposure distance setting between a number of the hair-cutting units 4 while using, for example, a common driving gear wheel 52 as shown in FIG. 7 in respect of the hair-cutting units 4 according to the first practical embodiment of the invention, for simultaneously driving all of the external cutting members 10 of the respective hair-cutting units 4. As soon as the maximum of the exposure distance de is set and the carrier portion 33 is put in motion in one hair-cutting unit 4, the fact that the external cutting member 10 is still rotated in unison with the external cutting members 10 of the other hair-cutting units 4 does not influence the exposure distance setting any further. Eventually, the maximum of the exposure distance de is achieved in each of the hair-cutting units 4, at which point the synchronization is completed, and the direction of the rotation of the external cutting members 10 can be reversed in case another value than the maximum needs to be set in respect of the exposure distance de and the external cutting members 10 can be rotated in unison over the appropriate angle about the respective central axes 14 until the desired exposure distance setting is actually achieved. It is to be noted that as soon as the direction of the rotation of the external cutting members 10 is reversed and the following element 42 moves away from the initial position in the guiding channel 41, the moment acting on the carrier portion 33 in the tangential direction about the central axis 14 is removed, so that the carrier portion 33 is stationary in the main portion of the supporting member 30 again due to the corrugated annular surface 36 of the carrier portion 33 and the corrugated annular surface 35 of the main portion of the supporting member 30 engaging each other and fixing each other on the basis of friction.

In respect of the releasable arrangement of the carrier portion 33 in the main portion of the supporting member 30, it is noted that correct functioning is obtained if, in the tangential direction about the central axis 14, the frictional moment that is needed to realize mutually relative rotation of the carrier portion 33 and the main portion of the supporting member 30 is higher than the frictional moment that is needed to realize mutually relative rotation of the carrier portion 33 and the component 19 which is mounted to the external cutting member 10 and that includes the following elements 42 and the driven gear wheel 51. Hence, this is a determining factor in choices in respect of material and holding features between the carrier portion 33 and the main portion of the supporting member 30, wherein it is to be noted that alternatives to using the shown combination of corrugated annular surfaces 35, 36 between the carrier portion 33 and the main portion of the supporting member 30 are feasible in the context of the invention.

In view of the foregoing explanation of the way in which the exposure distance setting is synchronized between different hair-cutting units 4 according to the second practical embodiment of the invention, and with reference to what is noted in the foregoing in respect of the hair-cutting unit 4 according to the first practical embodiment of the invention, it is understood that it may be practical if a method of controlling of a shaving assembly 3 comprising a number of hair-cutting units 4 according to the second practical embodiment of the invention is chosen which involves a step aimed at initially enabling the following element 42 to reach the initial position in the guiding channel 41 in each of the adjustment sets of each of the hair-cutting units 4, i.e. a step aimed at synchronizing the exposure distance setting between the hair-cutting units 4 during an initial operational phase of the shaving assembly 3.

When FIGS. 4 and 5 are seen in relation to the hair-cutting unit 4 according to the second practical embodiment of the invention, it is found that a change of the situation illustrated in FIG. 4 to the situation illustrated in FIG. 5 involves a movement of the following element 42 in the guiding channel 41 that is directed away from the initial position in the guiding channel 41, as such movement involves a decrease of the exposure distance de in the hair-cutting unit 4. This is a movement that is achieved on the basis of a clockwise rotation of the external cutting member 10 about the central axis 14, as seen from the bottom side, which may be invoked by rotating a common, central driving gear wheel 52 in the counterclockwise direction as seen from the bottom side.

With reference to FIGS. 6, 9 and 11, and in view of the possibility of disassembling and subsequently assembling of hair-cutting units 4 by a user, it is noted that it is practical if the guiding channel 41 comprises an opening 45 via which the following element 42 can be removed from the guiding channel 41 by manually moving the external cutting member 10 and the supporting member 30 relative to each other in the axial direction A. In this respect, it is further noted that it may be practical if operation of the hair-cutting unit 4 is controlled in such a way that the following element 42 is prevented from reaching the position in the guiding channel 41 where the opening 45 is present during an actual shaving action or if other measures are taken to prevent the following element 42 from passing through the opening 45 during normal operation of the hair-cutting unit 4.

It will be clear to a person skilled in the art that the scope of the invention is not limited to the examples discussed in the foregoing, and that several amendments and modifications thereof are possible without deviating from the scope of the invention as defined in the attached claims. It is intended that the invention be construed as including all such amendments and modifications insofar they come within the scope of the claims or the equivalents thereof. While the invention has been illustrated and described in detail in the figures and the description, such illustration and description are to be considered illustrative or exemplary only, and not restrictive. The invention is not limited to the disclosed embodiments. The drawings are schematic, wherein details which are not required for understanding the invention may have been omitted, and not necessarily to scale.

Variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. Any reference signs in the claims should not be construed as limiting the scope of the invention.

Elements and aspects discussed for or in relation with a particular embodiment may be suitably combined with elements and aspects of other embodiments, unless explicitly stated otherwise. Thus, the mere fact that certain measures are recited in mutually different dependent claims does not indicate that a combination of these measures cannot be used to advantage.

The terms “comprise” and “include” as used in the present text will be understood by a person skilled in the art as covering the term “consist of”. Hence, the term “comprise” or “include” may in respect of an embodiment mean “consist of”, but may in another embodiment mean “contain/have/be equipped with at least the defined species and optionally one or more other species”.

Notable aspects of the invention are summarized as follows. In a hair-cutting unit 4 for a rotary electric shaver 1, which is of the type comprising an external cutting member 10, an internal cutting member 20 and a supporting member 30, an exposure distance de over which a skin-contacting surface 12 of a shaving track 11 of the external cutting member 10 protrudes relative to an upper surface 31 of the supporting member 30 is adjustable. To this end, an adjustment system is provided, which comprises, among other things, at least one adjustment set of a guiding channel 41 and a following element 42 engaging the guiding channel 41, and also an initial position setting system configured to enable synchronization of the exposure distance setting between a number of the hair-cutting units 4, wherein an initial position of the following element 42 in the guiding channel 41 defined by a stop arrangement 43 of the guiding channel 41 is realized and maintained. In particular, the synchronization involves enabling preservation of said position of the following element 42 in the guiding channel 41 in the at least one adjustment set of one hair-cutting unit 4 when the following element 42 actually reaches said position as a result of a mutually relative rotation of the external cutting member 10 and the supporting member 30 about a central axis 14 of the hair-cutting unit 4 in an appropriate rotational direction about the central axis 14, while still allowing realization of a displacement of the following element 42 towards said position in the at least one adjustment set of another hair-cutting unit 4 in which the following element 42 has not yet reached said position as the mutually relative rotation of the external cutting member 10 and the supporting member 30 about the central axis 14 in the appropriate rotational direction about the central axis 14 is continued.

1. Hair-cutting unit for a rotary electric shaver, comprising:
an external cutting member with a shaving track having hair-entry openings;
an internal cutting member which is covered by and rotatable relative to the external cutting member about a central axis of the hair-cutting unit;
a supporting member surrounding and supporting the external cutting member; and
an adjustment system to adjust an exposure distance over which a skin-contacting surface of the shaving track protrudes relative to an upper surface of the supporting member, comprising an adjustment actuator and an adjustment transmission system via which the adjustment actuator is enabled to adjust the exposure distance through mutually relative rotation of the external cutting member and the supporting member about the central axis, wherein the adjustment transmission system comprises a conversion mechanism to convert a mutually relative rotation of the external cutting member and the supporting member about the central axis into a mutually relative axial movement of the external cutting member and the supporting member in an axial direction parallel to the central axis;
wherein:
the conversion mechanism comprises at least one set of a guiding channel and a following element engaging the guiding channel;
the guiding channel is inclined relative to an imaginary surface perpendicular to the central axis, and is provided on one of i) an inner surface of the supporting member surrounding the external cutting member and ii) a circumferential outer surface of the external cutting member;
the following element is provided on the other one of i) said inner surface of the supporting member and ii) said outer surface of the external cutting member;
the guiding channel comprises a stop arrangement defining an initial position for the following element in the guiding channel corresponding to one of a minimum and a maximum of the exposure distance;
the adjustment actuator is operable in a first active state to realize mutually relative rotation of the external cutting member and the supporting member in a first rotational direction about the central axis whereby displacement of the following element in a direction towards the initial position in the guiding channel is obtained, and in a second active state to realize mutually relative rotation of the external cutting member and the supporting member in a second rotational direction about the central axis that is opposite to the first rotational direction; and
the adjustment transmission system further comprises an initial position setting system configured to stop the mutually relative axial movement of the external cutting member and the supporting member, and, thereby, to maintain said one of the minimum and the maximum of the exposure distance, during continued operation of the adjustment actuator in the first active state, when the following element reaches the initial position in the guiding channel.

2. Hair-cutting unit as claimed in claim 1, wherein the external cutting member is rotatable relative to the supporting member about the central axis.

3. Hair-cutting unit as claimed in claim 2, wherein:
the adjustment transmission system comprises a driven gear wheel mounted to the external cutting member and the adjustment actuator comprises a driving gear wheel engaging the driven gear wheel; and
the first and second active states of the adjustment actuator involve respective opposite first and second directions of rotation of the driving gear wheel.

4. Hair-cutting unit as claimed in claim 2, wherein the initial position setting system is configured to disable the adjustment actuator to act on the external cutting member, during continued operation of the adjustment actuator in the first active state, when the following element reaches the initial position in the guiding channel.

5. Hair-cutting unit as claimed in claim 4, wherein:
the initial position setting system comprises, for each set of a guiding channel and a following element, a void section of the driven gear wheel in which no gear teeth are present; and
the void section is positioned relative to the one of the guiding channel and the following element which is provided on said outer surface of the external cutting member such that the void section faces the driving gear wheel to disable the driving gear wheel from driving the driven gear wheel when the following element is at the initial position in the guiding channel.

6. Hair-cutting unit as claimed in claim 5, wherein the stop arrangement of the guiding channel of one of the at least one set of a guiding channel and a following element comprises a resilient element configured to bias the following element out of the initial position in the guiding channel when the following element is at the initial position in the guiding channel.

7. Hair-cutting unit as claimed in claim 2, wherein:
the guiding channel is provided on a carrier portion of the supporting member; and
the initial position setting system is configured to enable rotation of the carrier portion relative to a main portion of the supporting member about the central axis together with the external cutting member, during continued operation of the adjustment actuator in the first active state, when the following element reaches the initial position in the guiding channel.

8. Hair-cutting unit as claimed in claim 7, wherein the initial position setting system comprises a holding arrangement to retain the carrier portion in a stationary position in the main portion of the supporting member when the following element is at another position than the initial position in the guiding channel, and to enable the carrier portion to rotate relative to the main portion of the supporting member about the central axis when the adjustment actuator operates in the first active state and the following element reaches the initial position in the guiding channel.

9. Hair-cutting unit as claimed in claim 8, wherein the holding arrangement comprises friction structures in surfaces of the carrier portion and/or the main portion of the supporting member contacting each other and extending in a tangential direction about the central axis.

10. Hair-cutting unit as claimed in claim 1, wherein the guiding channel comprises an opening via which the following element can be removed from the guiding channel by manually moving the external cutting member and the supporting member relative to each other in the axial direction.

11. Hair-cutting unit as claimed in claim 1, wherein the conversion mechanism comprises three sets of a guiding channel and a following element, the three sets being arranged at angular intervals of 120° about the central axis.

12. Shaving assembly, comprising at least two hair-cutting units as claimed in claim 1 and a base unit supporting the at least two hair-cutting units.

13. Shaving assembly as claimed in claim 12, wherein the adjustment actuator of each of the hair-cutting units is configured to be operated in the first active state during an initial operational phase of the shaving assembly, such that, in each of the hair-cutting units, the following element of the at least one set of a guiding channel and a following element is enabled to reach the initial position in the guiding channel.

14. Shaving assembly as claimed in claim 12, wherein the adjustment systems of the hair-cutting units comprise a common adjustment actuator, and wherein the common adjustment actuator comprises a common driving gear wheel arranged centrally between the hair-cutting units.

15. Rotary electric shaver comprising a main body and a shaving assembly as claimed in claim 12, wherein the base unit of the shaving assembly is connected to the main body.
